(19) United States
(12) Patent Application Publication
(10) Pub. No.: US 2025/0113211 A1
(43) Pub. Date: Apr. 3, 2025

(54) Methods And Apparatus For Response Of Beam Reporting In Mobile Communications

(71) Applicant: MediaTek Inc., Hsinchu City (TW)

(72) Inventors: Yi-Ru Chen, Hsinchu City (TW); Cheng-Rung Tsai, Hsinchu City (TW)

(21) Appl. No.: 18/818,929

(22) Filed: Aug. 29, 2024

Related U.S. Application Data
(60) Provisional application No. 63/585,989, filed on Sep. 28, 2023.

(51) Int. Cl. H04W 16/28; H04W 24/10; H04W 72/232

(52) U.S. Cl. CPC H04W 16/28; H04W 24/10; H04W 72/232

(57) ABSTRACT

Various solutions for response of beam reporting with respect to user equipment and network node in mobile communications are described. An apparatus may transmit a report indicating at least one beam to a network node. The apparatus may receive a downlink control information (DCI) indicating an indicator from the network node within an effective duration corresponding to the report. The apparatus may determine whether the report is received or confirmed by the network node according to the indicator. The apparatus may perform a beam switching or a beam synchronization based on the at least one beam indicated in the report if the report is received or confirmed by the network node.

### CROSS REFERENCE TO RELATED PATENT APPLICATION(S)

The present disclosure is part of a non-provisional application claiming the priority benefit of U.S. patent application Ser. No. 63/585,989, filed 28 Sep. 2023, the content of which herein being incorporated by reference in its entirety.

### TECHNICAL FIELD

The present disclosure is generally related to mobile communications and, more particularly, to response for beam reporting with respect to user equipment (UE) and network apparatus in mobile communications.

### BACKGROUND

Unless otherwise indicated herein, approaches described in this section are not prior art to the claims listed below and are not admitted as prior art by inclusion in this section.

In conventional beam management procedure, the network node may transmit at least one downlink (DL) reference signal (RS) to the UE. Then, the UE may perform a measurement according to the DL RS to generate a beam report. However, when the network node does not receive the beam report successfully, the UE cannot know whether the network node has received or confirmed the beam report. Therefore, the ambiguity between the UE and the network node due to the missing/failure of the beam report may occur.

Accordingly, how to respond to the beam report becomes an important issue for the newly developed wireless communication network. Therefore, there is a need to provide proper schemes to reduce an ambiguity on whether the network node receives the beam report from the UE successfully.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to response for beam reporting with respect to user equipment and network apparatus in mobile communications. It is believed that the above-described issue would be avoided or otherwise alleviated by implementing one or more of the proposed schemes described herein.

In one aspect, a method may involve an apparatus transmitting a report indicating at least one beam to a network node. The method may also involve the apparatus receiving a downlink control information (DCI) indicating an indicator from the network node within an effective duration corresponding to the report. The method may also involve the apparatus determining whether the report is received or confirmed by the network node according to the indicator. The method may further involve the apparatus performing a beam switching or a beam synchronization based on the at least one beam indicated in the report in an event that the report is received or confirmed by the network node.

In another aspect, an apparatus may involve a transceiver which, during operation, wirelessly communicates with at least one network node. The apparatus may also involve a processor communicatively coupled to the transceiver such that, during operation, the processor may transmit, via the transceiver, a report indicating at least one beam to a network node. The processor may also receive, via the transceiver, a DCI indicating an indicator from the network node within an effective duration corresponding to the report. The processor may also determine whether the report is received or confirmed by the network node according to the indicator. The processor may further perform a beam switching or a beam synchronization based on the at least one beam indicated in the report in an event that the report is received or confirmed by the network node.

In another aspect, a method may involve a network node receiving a report indicating at least one beam from a user equipment (UE). The method may also involve the network node determining a DCI associated with the report. The method may further involve the network node transmitting the DCI indicating an indicator to the UE within an effective duration corresponding to the report, wherein the indicator may indicates whether the report is received or confirmed by the network node.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (Iyo), Narrow Band Internet of Things (NB-IoT), 6^{th} Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for a beam reporting procedure in accordance with implementations of the present disclosure.

FIG. 3 is a diagram depicting another example scenario for a beam reporting procedure in accordance with implementations of the present disclosure.

FIG. 4 is a diagram depicting another example scenario for a beam reporting procedure in accordance with implementations of the present disclosure.

FIG. 5 is a diagram depicting another example scenario for a beam reporting procedure in accordance with implementations of the present disclosure.

FIG. 6 is a diagram depicting another example scenario for a beam reporting procedure in accordance with implementations of the present disclosure.

FIG. 7 is a diagram depicting another example scenario for a beam reporting procedure in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to response for beam reporting with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

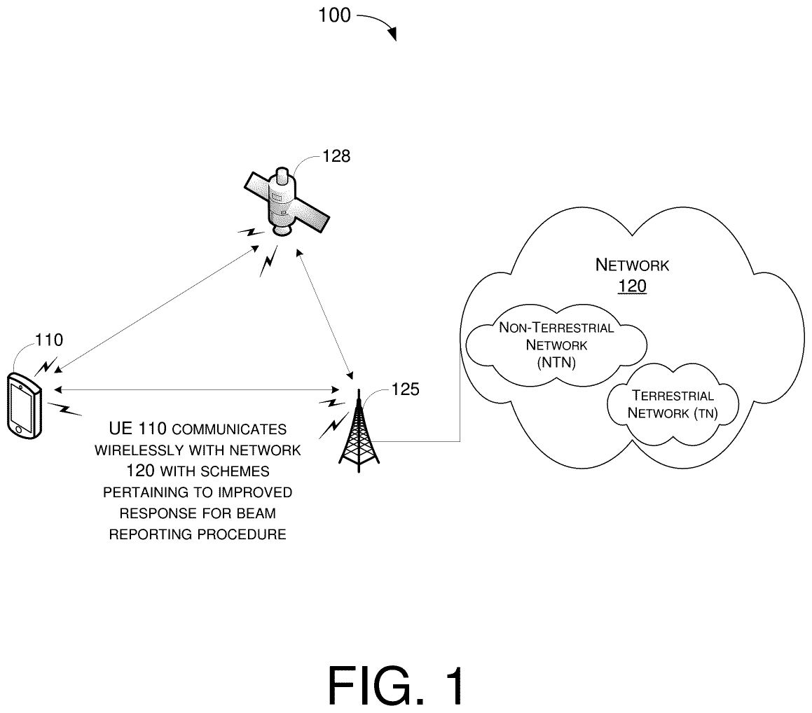

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 110, the network 120, the terrestrial network node 125, and the non-terrestrial network node 128 may implement various schemes pertaining to improved response for beam reporting procedure in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

According to the implementations of the present disclosure, a UE (e.g., the UE 110) may transmit a report (or beam report) indicating at least one beam to a network node (e.g., the terrestrial network node 125).

The beam report may indicate the beam (or beams) which has (or have) been synchronized by the apparatus. In an example, all beams indicated in the beam report have been synchronized by the apparatus. In another example, the beam report may comprise an indicator. The indicator may indicate the beam (or beams) which has (or have) been synchronized by the apparatus and indicate the beam (or beams) which has (or have) not been synchronized by the apparatus. In addition, the beam report may comprise at least one RS index (or RS identification (ID)) or at least one transmission configuration indicator (TCI) state index (or TCI state ID) associated with the beam (or beams). The beam or beams indicated in the beam report may be indicated by one reference signal index or one transmission configuration indicator (TCI) state index. That is, the UE may report (or indicate) a beam by its associated RS index or TCI-state index in the beam report. Each beam in the beam report may be indicated by its associated RS index or TCI-state index. Each RS index may be associated with a different TCI state index. In an example, when an RS or a TCI state reported in the beam report is indicated as “synchronized”, it means that the UE has performed synchronization for the beam associated with the TCI-state or the RS. In another example, when an RS or a TCI state reported in the beam report is indicated as “unsynchronized”, it means that the UE has not performed synchronization for the beam associated with the TCI-state or the RS.

After transmitting the beam report to the network node, the UE may determine whether a downlink control information (DCI) associated with the beam report is received from the network node within an effective duration corresponding to the beam report. In an event that the UE receives the DCI from the network node within an effective duration corresponding to the beam report, the UE may determine whether the beam report is received or confirmed by the network node according to the DCI.

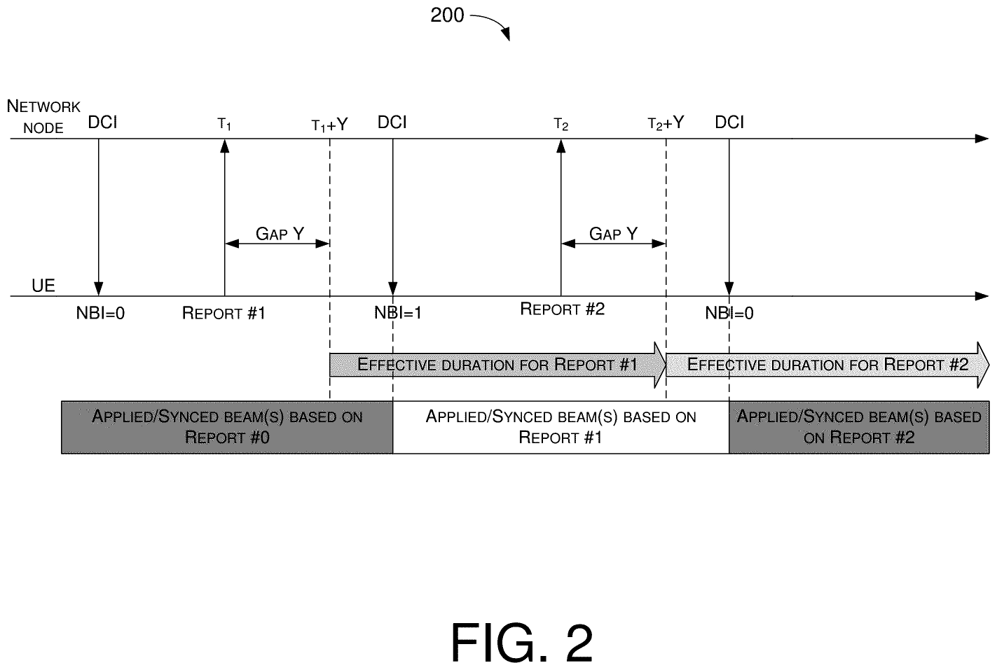

After the UE transmits the beam report to the network node, the beam report may be effective after a gap duration. That is, the effective duration corresponding to the beam report may be started after a gap duration, and the gap duration may be started after the beam report is transmitted to the network node. As shown in FIG. 2, the beam report (Report #1) transmitted to the network node at the time point t₁ may be effective after the time point t₁+Y until a new beam report (Report #2) transmitted to the network node at the time t₂ is effective at the time point t₂+Y, i.e., the effective duration for the beam report (Report #1) is from the time point t₁+Y to the time point t₂+Y. According to the implementations of the present disclosure, the gap duration may be determined based on a UE capability, configured by the network node, or configured by the network node based on a UE capability. In an example, the length of the gap duration may be zero.

The DCI from the network node may comprise an indicator (e.g., a new beam indicator (NBI)) to indicate whether the beam report is received or confirmed by the network node.

In an example, in an event that the beam report is received or confirmed by the network node within the effective duration corresponding to the beam report, the network node may set the indicator to a value which is different from a prior value of a prior indicator. For example, if a prior value of a prior indicator is a first value (e.g., prior NBI=1), in an event that the beam report is received or confirmed by the network node within the effective duration corresponding to the beam report, the network node may set the indicator to a second value (e.g., NBI=0, i.e., the value of NBI is toggled or changed).

In another example, in an event that the beam report is not received or not confirmed by the network node, the network node may set the indicator to a value which is the same as a prior value of a prior indicator. For example, if a prior value of a prior indicator is a first value (e.g., prior NBI=1), in an event that the beam report is not received or confirmed by the network node within the effective duration corresponding to the beam report, the network node may set the indicator to the first value (e.g., NBI=1, i.e., the value of NBI is not toggled or changed).

The network node may determine not to change a value of the indicator in a new DCI in an event that no new beam report is received from the UE. Specifically, if the network node does not receive a new beam report from the UE, and the network node needs to transmit a new DCI to the UE, the network node may not change the value of the indicator in the new DCI (e.g., transmit a new DCI with non-toggled NBI). In other words, if no new beam report is received from the UE, the network node cannot transmit a new DCI with toggled NBI to the UE within the effective duration corresponding to the new beam report.

In another example, the network node may determine not to transmit the DCI to the UE in an event that network node does not receive the beam report from the UE.

When the UE determines that the DCI associated with the beam report is received from the network node within the effective duration corresponding to the beam report, the UE may determine whether to perform a beam switching or a beam synchronization based on the beam report according to the DCI. In an example, the UE may determine to perform a beam switching or a beam synchronization based on the beam or beams indicated in the beam report in an event that the beam report is received or confirmed by the network node (i.e., a value of the indicator in the DCI is different from a prior value (e.g., the DCI with toggled NBI)). In another example, the UE may maintain at least one beam in a prior beam report in an event that the beam report is not received or not confirmed by the network node (i.e., a value of the indicator in the DCI is the same as a prior value (e.g., the DCI with non-toggled NBI)).

When the UE determines that the DCI associated with the beam report is not received from the network node within the effective duration corresponding to the beam report, the UE may maintain at least one beam in a prior beam report.

FIG. 2 illustrates an example scenario 200 for a beam reporting procedure in accordance with implementations of the present disclosure. Scenario 200 involves a UE and a network node (e.g., a (macro/micro) base station) of a serving cell which may be a part of a wireless network (e.g., an LTE network, a 5G/NR network, an IoT network or a 6G network). Referring to FIG. 2, the UE may transmit a beam report (i.e., Report #1) to the network at time point t₁. The Report #1 may be effective at time point t₁+Y (i.e., after the gap duration GAP Y). In addition, the Report #1 may be effective from the time point t₁+Y to the time point t₂+Y (i.e., the effective duration for the Report #1). During the effective duration for the Report #1, the UE receives a DCI with toggled NBI (i.e., the value of NBI is changed from “0” to “1”). Therefore, the UE can know that the Report #1 has been confirmed by the network node. The UE may perform a beam switching or a beam synchronization based on the Report #1 (e.g., apply or synchronize the beam or beams from the Report #1) after receiving the DCI. Then, the UE may transmit a next beam report (i.e., Report #2) to the network at time point t₂. The Report #2 may be effective at time point t₂+Y (i.e., after the gap duration GAP Y). In addition, the Report #2 may be effective from the time point t₂+Y to the time point of a next beam report being effective (i.e., the effective duration for the Report #2). During the effective duration for the Report #2, the UE receives a new DCI with toggled NBI (i.e., the value of NBI is changed from “1” to “0”). Therefore, the UE can know that the Report #2 has been confirmed by the network node. The UE may perform a beam switching or a beam synchronization based on the Report #2 (e.g., apply or synchronize the beam or beams from the Report #2) after receiving the new DCI.

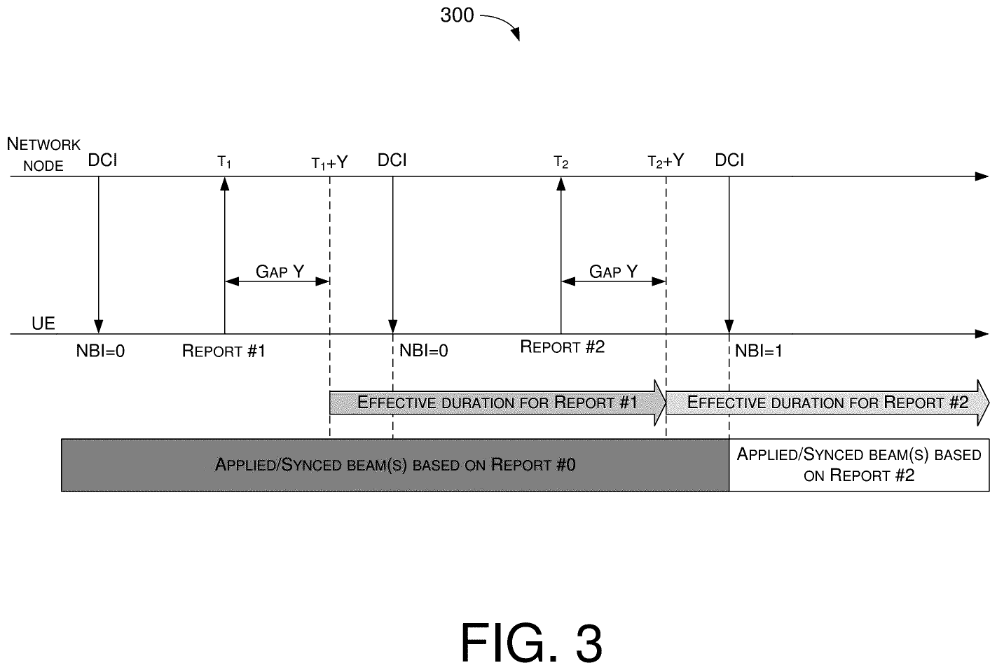

FIG. 3 illustrates another example scenario 300 for a beam reporting procedure in accordance with implementations of the present disclosure. Scenario 300 involves a UE and a network node (e.g., a (macro/micro) base station) of a serving cell which may be a part of a wireless network (e.g., an LTE network, a 5G/NR network, an IoT network or a 6G network). Referring to FIG. 3, the UE may transmit a beam report (i.e., Report #1) to the network at time point t₁. The Report #1 may be effective at time point t₁+Y (i.e., after the gap duration GAP Y). In addition, the Report #1 may be effective from the time point t₁+Y to the time point t₂+Y (i.e., the effective duration for the Report #1). During the effective duration for the Report #1, the UE receives a DCI with non-toggled NBI (i.e., the value of NBI is not changed). Therefore, the UE can know that the Report #1 may not be confirmed by the network node. The UE may perform a beam switching or a beam synchronization based on the Report #0 (e.g., maintain at least one beam in the Report #0). Then, the UE may transmit a next beam report (i.e., Report #2) to the network at time point t₂. The Report #2 may be effective at time point t₂+Y (i.e., after the gap duration GAP Y). In addition, the Report #2 may be effective from the time point t₂+Y to the time point of a next beam report being effective (i.e., the effective duration for the Report #2). During the effective duration for the Report #2, the UE receives a new DCI with toggled NBI (i.e., the value of NBI is changed from “1” to “0”). Therefore, the UE can know that the Report #2 has been confirmed by the network node. The UE may perform a beam switching or a beam synchronization based on the Report #2 (e.g., apply or synchronize the beam or beams from the Report #2) after receiving the new DCI.

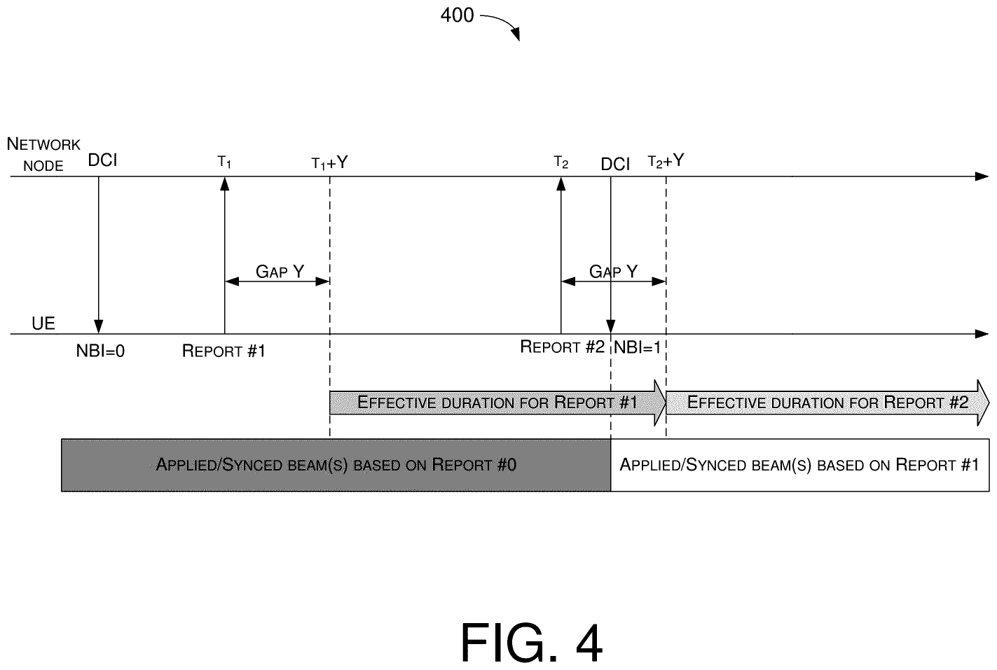

FIG. 4 illustrates another example scenario 400 for a beam reporting procedure in accordance with implementations of the present disclosure. Scenario 400 involves a UE and a network node (e.g., a (macro/micro) base station) of a serving cell which may be a part of a wireless network (e.g., an LTE network, a 5G/NR network, an IoT network or a 6G network). Referring to FIG. 4, the UE may transmit a beam report (i.e., Report #1) to the network at time point t₁. The Report #1 may be effective at time point t₁+Y (i.e., after the gap duration GAP Y). In addition, the Report #1 may be effective from the time point t₁+Y to the time point t₂+Y (i.e., the effective duration for the Report #1). During the effective duration for the Report #1, the UE receives a DCI with toggled NBI (i.e., the value of NBI is changed from “0” to “1”). Therefore, the UE can know that the Report #1 has been confirmed by the network node. The UE may perform a beam switching or a beam synchronization based on the Report #1 (e.g., apply or synchronize the beam or beams from the Report #1) after receiving the DCI. In the example, the UE receives the DCI after transmitting a next beam report (i.e., Report #2), but the Report #2 has not been effective (i.e., not in the effective duration for the Report #2). Therefore, the UE may perform the beam switching or the beam synchronization based on the Report #1.

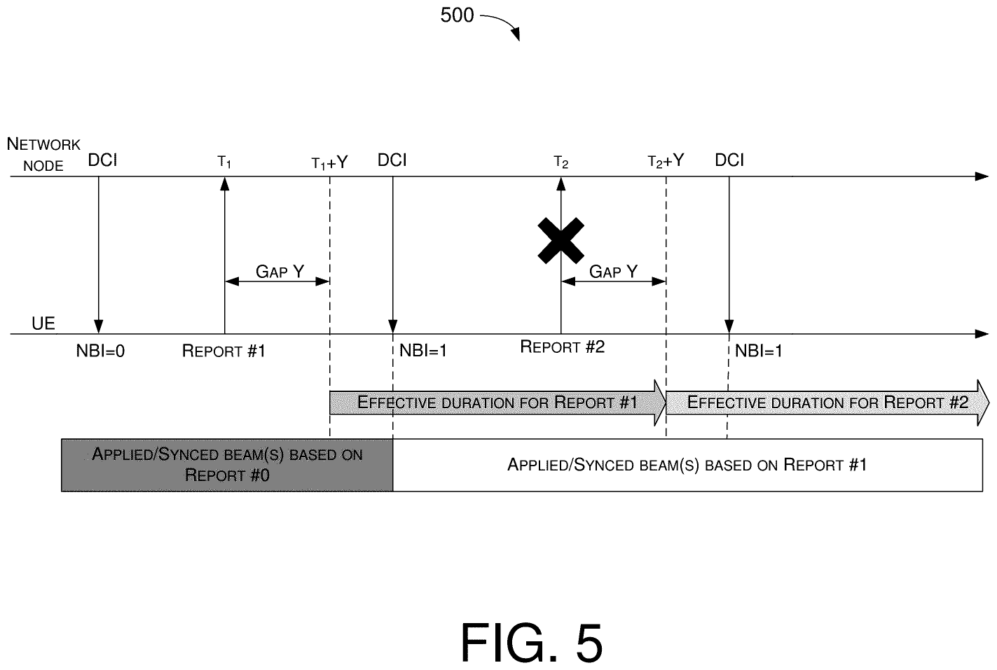

FIG. 5 illustrates another example scenario 500 for a beam reporting procedure in accordance with implementations of the present disclosure. Scenario 500 involves a UE and a network node (e.g., a (macro/micro) base station) of a serving cell which may be a part of a wireless network (e.g., an LTE network, a 5G/NR network, an IoT network or a 6G network). Referring to FIG. 5, the UE may transmit a beam report (i.e., Report #1) to the network at time point t₁. The Report #1 may be effective at time point t₁+Y (i.e., after the gap duration GAP Y). In addition, the Report #1 may be effective from the time point t₁+Y to the time point t₂+Y (i.e., the effective duration for the Report #1). During the effective duration for the Report #1, the UE receives a DCI with toggled NBI (i.e., the value of NBI is changed from “0” to “1”). Therefore, the UE can know that the Report #1 has been confirmed by the network node. The UE may perform a beam switching or a beam synchronization based on the Report #1 (e.g., apply or synchronize the beam or beams from the Report #1) after receiving the DCI. Then, the UE may transmit a next beam report (i.e., Report #2) to the network at time point t₂. However, the network node does not receive the Report #2 successfully. Therefore, when the network node transmit a new DCI to the UE during the effective duration for the Report #2, the value of the NBI in the new DCI will not be changed (i.e., the value of the NBI is the same as a prior value), i.e., the new DCI with non-toggled NBI. Therefore, during the effective duration for the Report #2, the UE may perform the beam switching or the beam synchronization based on the Report #1 (e.g., maintain at least one beam in the Report #1) after receiving the new DCI.

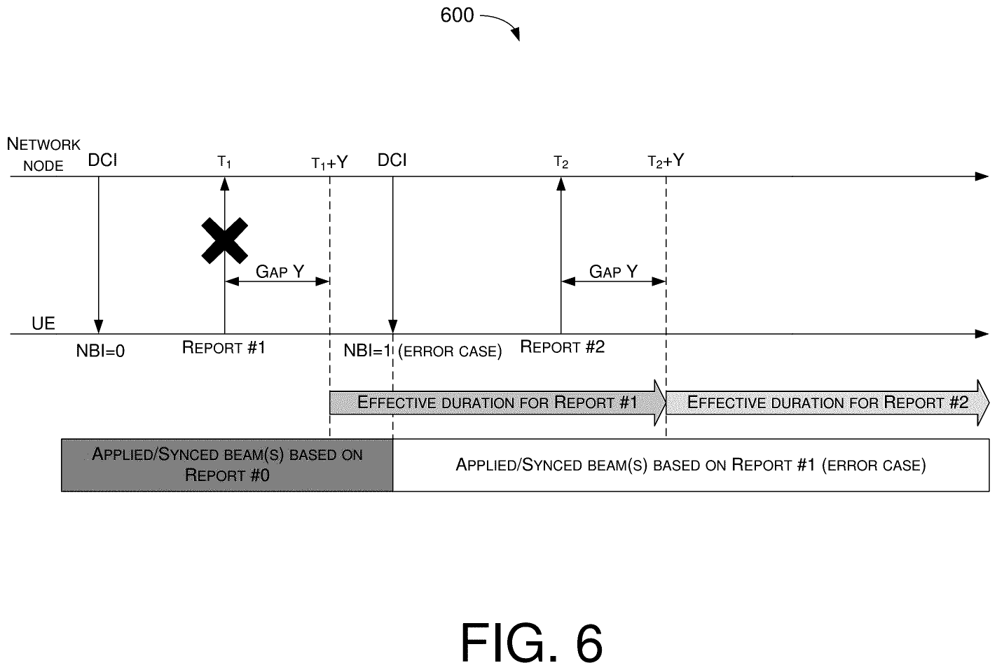

FIG. 6 illustrates another example scenario 600 for a beam reporting procedure in accordance with implementations of the present disclosure. Scenario 600 involves a UE and a network node (e.g., a (macro/micro) base station) of a serving cell which may be a part of a wireless network (e.g., an LTE network, a 5G/NR network, an IoT network or a 6G network). Referring to FIG. 6, the UE may transmit a beam report (i.e., Report #1) to the network at time point t₁. The Report #1 may be effective at time point t₁+Y (i.e., after the gap duration GAP Y). In addition, the Report #1 may be effective from the time point t₁+Y to the time point t₂+Y (i.e., the effective duration for the Report #1). However, the network node does not receive the Report #1 successfully. Therefore, when the network node transmit a DCI to the UE during the effective duration for the Report #1, the value of the NBI in the new DCI cannot be changed (i.e., the DCI cannot comprise a toggled NBI). That is, in the example, it is an error case that during the effective duration for the Report #1, the UE receives a DCI with toggled NBI (i.e., the value of NBI is changed from “0” to “1”).

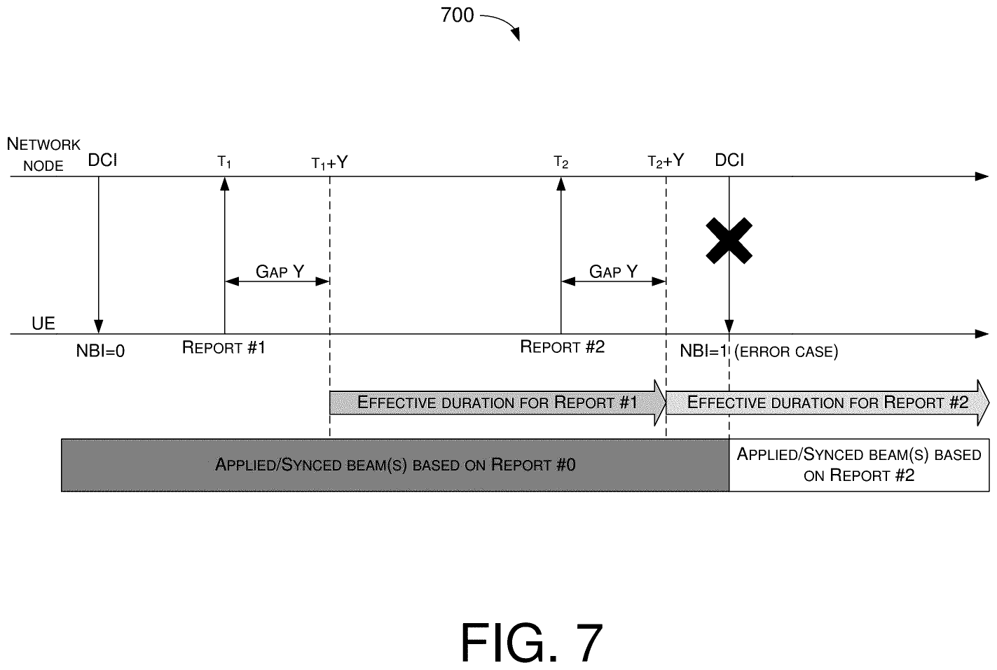

FIG. 7 illustrates another example scenario 700 for a beam reporting procedure in accordance with implementations of the present disclosure. Scenario 700 involves a UE and a network node (e.g., a (macro/micro) base station) of a serving cell which may be a part of a wireless network (e.g., an LTE network, a 5G/NR network, an IoT network or a 6G network). Referring to FIG. 7, the UE may transmit a beam report (i.e., Report #1) to the network at time point t₁. The Report #1 may be effective at time point t₁+Y (i.e., after the gap duration GAP Y). In addition, the Report #1 may be effective from the time point t₁+Y to the time point t₂+Y (i.e., the effective duration for the Report #1). During the effective duration for the Report #1, the UE does not receive a DCI from the network node. Therefore, the UE may perform a beam switching or a beam synchronization based on the Report #0 (e.g., maintain at least one beam in the Report #0). Then, the UE may transmit a next beam report (i.e., Report #2) to the network at time point t₂. However, the network node does not receive the Report #2 successfully. Therefore, when the network node transmit a DCI to the UE during the effective duration for the Report #2, the value of the NBI in the new DCI cannot be changed (i.e., the DCI cannot comprise a toggled NBI). That is, in the example, it is an error case that during the effective duration for the Report #2, the UE receives a DCI with toggled NBI (i.e., the value of NBI is changed from “0” to “1”).

### Illustrative Implementations

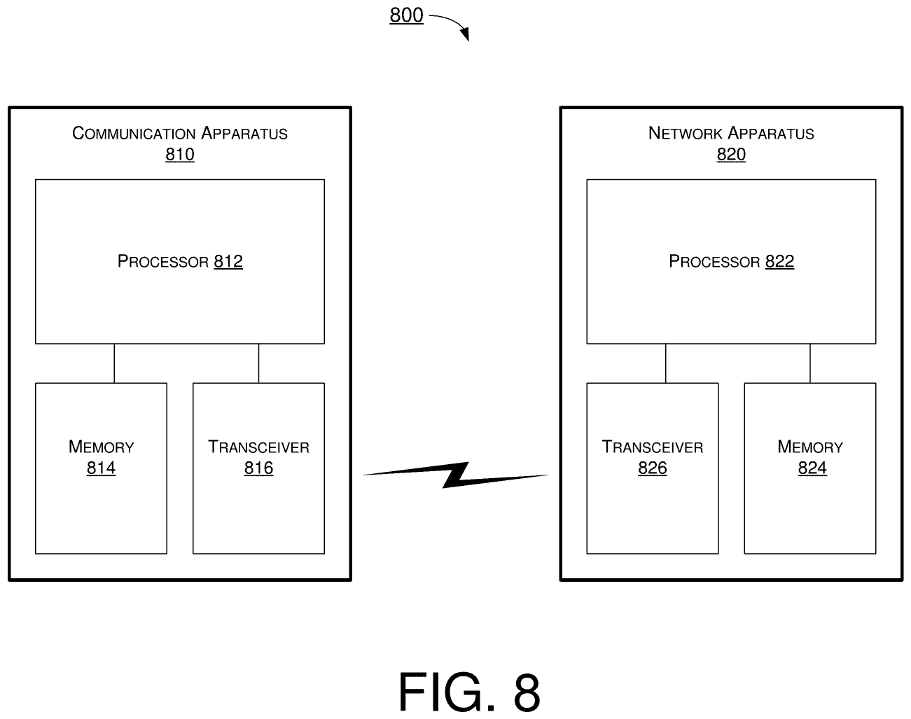

FIG. 8 illustrates an example communication system 800 having at least an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to response for beam reporting, including the various schemes described above with respect to various proposed designs, concepts, schemes and methods described above and with respect to user equipment and network apparatus in mobile communications, including scenarios/schemes described above as well as process 900 and process 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 810 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed schemes of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a satellite, a BS, a small cell, a router or a gateway of an IoT network. For instance, network apparatus 820 may be implemented in a satellite or an eNB/gNB/TRP in a 4G/5G/B5G/6G, NR, IoT, NB-IoT or IIoT network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks, including PHR for MTRP operation, in a device (e.g., as represented by communication apparatus 810) and a network node (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, transceiver 816 may be capable of wirelessly communicating with different types of UEs and/or wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, network apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, communication apparatus 810 may further include a memory 814 coupled to processor 812 and capable of being accessed by processor 812 and storing data therein. In some implementations, network apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 810 and network apparatus 820 may be a communication entity capable of communicating with each other using various proposed schemes in accordance with the present disclosure. For illustrative purposes and without limitation, descriptions of capabilities of communication apparatus 810, as a UE, and network apparatus 820, as a network node (e.g., TRP), are provided below with process 900 and process 1000.

### Illustrative Processes

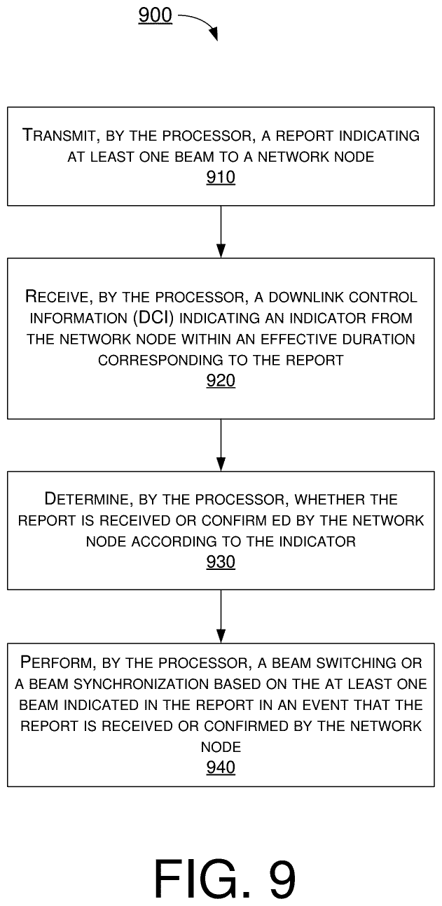

FIG. 9 illustrates an example process 900 in accordance with an implementation of the present disclosure. Process 900 may be an example implementation of above scenarios/schemes, whether partially or completely, with respect to response for beam reporting with the present disclosure. Process 900 may represent an aspect of implementation of features of communication apparatus 810. Process 900 may include one or more operations, actions, or functions as illustrated by one or more of blocks 910, 920, 930 and 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 transmitting, via transceiver 816 of communication apparatus 810, a report indicating at least one beam to a network node. Process 900 may proceed from block 910 to block 920.

At block 920, process 900 may involve processor 812 receiving, via transceiver 816, a DCI indicating an indicator from the network node within an effective duration corresponding to the report. Process 900 may proceed from block 920 to block 930.

At block 930, process 900 may involve processor 812 determining whether the report is received or confirmed by the network node according to the indicator. Process 900 may proceed from block 930 to block 940.

At block 940, process 900 may involve processor 812 performing a beam switching or a beam synchronization based on the at least one beam indicated in the report in an event that the report is received or confirmed by the network node.

In some implementations, the report may be determined as received or confirmed in an event that a value of the indicator is different from a prior value.

In some implementations, the effective duration corresponding to the report may be started after a gap duration, and the gap duration may be started after the report is transmitted to the network node.

In some implementations, the gap duration may be determined based on a UE capability, or configured by the network node.

In some implementations, the effective duration corresponding to the report may be ended in an event that the effective duration of a next report is started.

In some implementations, the at least one beam in the report may be indicated by a reference signal index or a TCI state index.

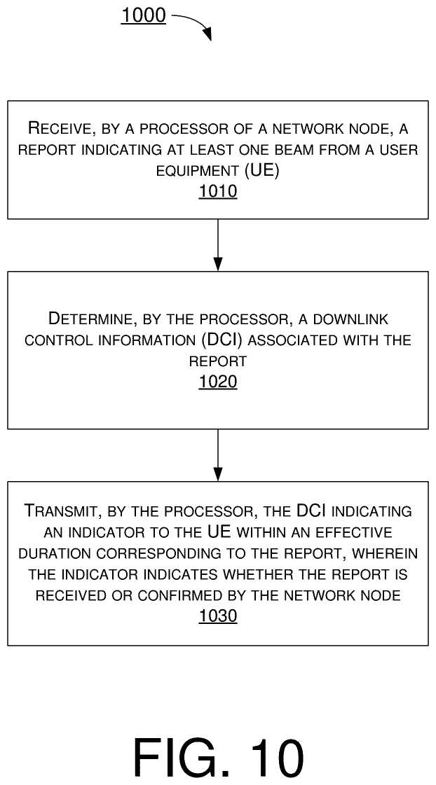

FIG. 10 illustrates an example process 1000 in accordance with another implementation of the present disclosure. Process 1000 may be an example implementation of above scenarios/schemes, whether partially or completely, with respect to response for beam reporting with the present disclosure. Process 1000 may represent an aspect of implementation of features of network apparatus 820. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any base stations or network nodes. Solely for illustrative purposes and without limitation, process 1000 is described below in the context of network apparatus 820. Process 1000 may begin at block 1010.

At block 1010, process 1000 may involve processor 822 of network apparatus 820 receiving, via transceiver 826 of network apparatus 820, a report indicating at least one beam from a UE. Process 1000 may proceed from block 1010 to block 1020.

At block 1020, process 1000 may involve processor 822 determining a DCI associated with the report. Process 1000 may proceed from block 1020 to block 1030.

At block 1030, process 1000 may involve processor 822 transmitting, via transceiver 826, the DCI indicating an indicator to the UE within an effective duration corresponding to the report. The indicator may indicate whether the report is received or confirmed by the network node.

In some implementations, the report may be determined as received or confirmed in an event that a value of the indicator is different from a prior value.

In some implementations, the effective duration corresponding to the report may be started after a gap duration, and the gap duration may be started after the report is received from the UE.

In some implementations, the gap duration may be determined based on a UE capability, or configured by the network node.

In some implementations, the effective duration corresponding to the report may be ended in an event that the effective duration of a next report is started.

In some implementations, the at least one beam in the report may be indicated by a reference signal index or a TCI state index.

In some implementations, process 1000 may involve processor 822 determining not to change a value of the indicator in a new DCI in an event that no new report is received from the UE.

In some implementations, process 1000 may involve processor 822 determining not to transmit the DCI to the UE in an event that network node does not receive the report from the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by the processor, a report indicating at least one beam to a network node;
receiving, by the processor, a downlink control information (DCI) indicating an indicator from the network node within an effective duration corresponding to the report;
determining, by the processor, whether the report is received or confirmed by the network node according to the indicator; and
performing, by the processor, a beam switching or a beam synchronization based on the at least one beam indicated in the report in an event that the report is received or confirmed by the network node.

2. The method of claim 1, wherein the report is determined as received or confirmed in an event that a value of the indicator is different from a prior value.

3. The method of claim 1, wherein the effective duration corresponding to the report is started after a gap duration, and wherein the gap duration is started after the report is transmitted to the network node.

4. The method of claim 3, wherein the gap duration is determined based on a user equipment (UE) capability, or configured by the network node.

5. The method of claim 1, wherein the effective duration corresponding to the report is ended in an event that the effective duration of a next report is started.

6. The method of claim 1, wherein the at least one beam in the report is indicated by a reference signal index or a transmission configuration indicator (TCI) state index.

7. An apparatus, comprising:
a transceiver which, within operation, wirelessly communicates with at least one network node; and
a processor communicatively coupled to the transceiver such that, within operation, the processor performs operations comprising:
transmitting, via the transceiver, a report indicating at least one beam to a network node;
receiving, via the transceiver, a downlink control information (DCI) indicating an indicator from the network node within an effective duration corresponding to the report;
determining whether the report is received or confirmed by the network node according to the indicator; and
performing a beam switching or a beam synchronization based on the at least one beam indicated in the report in an event that the report is received or confirmed by the network node.

8. The apparatus of claim 7, wherein the report is determined as received or confirmed in an event that a value of the indicator is different from a prior value.

9. The apparatus of claim 7, wherein the effective duration corresponding to the report is started after a gap duration, and wherein the gap duration is started after the report is transmitted to the network node.

10. The apparatus of claim 9, wherein the gap duration is determined based on a user equipment (UE) capability, or configured by the network node.

11. The apparatus of claim 7, wherein the effective duration corresponding to the report is ended in an event that the effective duration of a next report is started.

12. The apparatus of claim 7, wherein the at least one beam in the report is indicated by a reference signal index or a transmission configuration indicator (TCI) state index.

13. A method, comprising:
receiving, by a processor of a network node, a report indicating at least one beam from a user equipment (UE);
determining, by the processor, a downlink control information (DCI) associated with the report; and
transmitting, by the processor, the DCI indicating an indicator to the UE within an effective duration corresponding to the report,
wherein the indicator indicates whether the report is received or confirmed by the network node.

14. The method of claim 13, wherein the report is determined as received or confirmed in an event that a value of the indicator is different from a prior value.

15. The method of claim 13, wherein the effective duration corresponding to the report is started after a gap duration, and wherein the gap duration is started after the report is received from the UE.

16. The method of claim 15, wherein the gap duration is determined based on a UE capability, or configured by the network node.

17. The method of claim 13, wherein the effective duration corresponding to the report is ended in an event that the effective duration of a next report is started.

18. The method of claim 13, wherein the at least one beam in the report is indicated by a reference signal index or a transmission configuration indicator (TCI) state index.

19. The method of claim 13, further comprises:
determining, by the processor, not to change a value of the indicator in a new DCI in an event that no new report is received from the UE.

20. The method of claim 13, further comprises:
determining, by the processor, not to transmit the DCI to the UE in an event that network node does not receive the report from the UE.
